(19) United States
(12) Patent Application Publication
(10) Pub. No.: US 2026/0194255 A1
(43) Pub. Date: Jul. 9, 2026

(54) CLASS 0 Uninsulated Flexible Duct and Method Of Use

(71) Applicant: ROYAL METAL PRODUCTS, Temple, GA (US)

(72) Inventor: Ronald L. CARLAY, II, Laurens, SC (US)

(73) Assignee: ROYAL METAL PRODUCTS, Temple, GA (US)

(21) Appl. No.: 19/557,440

(22) Filed: Mar. 5, 2026

Related U.S. Application Data
(63) Continuation-in-part of application No. 19/280,756, filed on Jul. 25, 2025.
Application No. 19/280,756 is a continuation-in-part of application No. 18/125,264, filed on Mar. 23, 2023.
(60) Provisional application No. 63/323,937, filed on Mar. 25, 2022.
(60) Provisional application No. 63/677,865, filed on Jul. 31, 2024.
(60) Provisional application No. 63/770,622, filed on Mar. 12, 2025.

(51) Int. Cl. F24F 13/02; F16L 11/08

(52) U.S. Cl. CPC F24F 13/0218; F16L 11/081

(57) ABSTRACT

An uninsulated flexible duct includes a core made of a polymer material and including a helical wire as a part thereof, the polymer material core having inner and outer surfaces and including a first adhesive. The duct also includes a fire resistant barrier material surrounding the outer surface of the polymer material core, the fire resistant barrier material including a seam running longitudinally along the length of the uninsulated flexible duct, the longitudinal seam having an overlap zone that contains at least one second adhesive to maintain an integrity of the longitudinal seam. The uninsulated flexible duct is one that is free of any vapor barrier and has a flame spread index and smoke developed index of zero (0) as defined in the UL 181 standard. Component parts of the duct are controlled in terms of composition, amount, and/or configuration to achieve the Class 0 rating.

### FIELD OF INVENTION

A non-insulated flexible duct includes the combination of a fire resistant barrier material, a helical wire, a non-metallic or polymer material, and one or more adhesives securing the components of the duct together. The duct includes features as part of one or more of the polymer material in terms of its makeup and amount used in the duct, the one or more adhesives, the pitch of the helical wire, and the flame resistant barrier material that enable the duct to meet the UL 181 standards for a Class Zero (0) rating, including having a flame spread index and a smoke-developed index of zero.

### BACKGROUND ART

In the flexible duct industry, UL rates ducts with different classifications. One classification is a Class 0 duct, wherein the duct has both a flame spread index and a smoke-developed index of zero when tested in accordance with ASTM E84/UL723. In contrast, a Class 1 rated duct will have a flame spread index of 25 or less and a smoke-developed index of 50 or less. The lowest flame spread and smoke-developed is typically based on the performance of fibrous cement board when tested according to the ASTM standard while the upper end of the scale is based on the performance of red oak. Class 0 duct indicates the lowest level of flammability and minimal smoke developed. Class 0 ducts are typically made of sheet metal. Most flexible air ducts produced (with the exception of some corrugated metal types) are class 1 rated, which are often indicated as ASTM E84 25/50.

In order to achieve a UL classification rating for a flexible duct, both the inside and outside surfaces of the duct must be tested separately, and they must each perform at the required levels. So, to achieve a classification for the flame spread index and a smoke-developed index test, hereinafter the UL 723 test, the inside surface of the duct must be placed face-down into the tunnel (exposed directly to the flame) and tested. Then, for separate test articles, the outside surface of the duct must be placed face down into the tunnel and tested. The duct rating is determined by the poorest performing (most flame spread and most smoke-developed) surface of the duct. Therefore, in order to achieve a Class 0 rating, both surfaces of the duct must exhibit 0 flame spread and 0 smoke-developed.

Since Class 0 ducts are generally made of metal and can be expensive, a need exists to provide alternatives to the existing Class 0 ducts. The invention responds to this need by providing an uninsulated flexible duct that does not have metal as its main component and is one that can meet the UL tests for a Class 0 rating, including passing the ASTM E84 test. The standard known as UL 181 Factory-Made Air Ducts and Air Connectors, the latest revision being Dec. 29, 2021, is well known and specifies the various testing requirements for a duct to be given a Class 1 or Class 0 rating, the standard incorporated in its entirety be reference herein.

### SUMMARY OF THE INVENTION

The invention provides an improvement in flexible uninsulated ducts that meet the UL 181 Class 1 duct standard. Another aspect of the invention is taking this Class 1 uninsulated flexible duct and modifying one of more of its component parts so that the uninsulated flexible duct can be classified as a Class 0 duct. The make up of the Class 1 duct is first described and then the modifications to this duct construction are described to enable the uninsulated flexible duct that would attain a Class 1 rating to also attain a Class 0 rating.

In one embodiment, the flexible uninsulated duct that meets Underwriter Laboratories (UL) 181 Class 1 duct standard has a polymer core that includes a helical wire as a part thereof, the polymer core forming an inner space for conditioned air flow, and having an outer surface. A fire resistant barrier layer is provided that surrounds the outer surface of the polymer core, the fire resistant barrier layer providing flame spreading and smoke development resistance such that the flexible uninsulated duct meets the UL 181 Class 1 duct standard. In the inventive duct construction, a first surface of the fire resistant barrier layer faces the outer surface of the polymer core and an outer surface of the fire resistant barrier layer is exposed to form an outer surface of the uninsulated duct.

While the polymer core can be any known polymer core typically used as part of a flexible duct construction, one example is a polymer core that uses a pair of PET layers with a helical wire positioned therebetween.

Since the inventive flexible insulated duct meets the UL 181 Class 1 duct standard, it can be installed in a structure at a length greater than 14 feet so as not to be considered a connector that falls under this standard as such a connector does not meet all of the tests required for a duct falling under the UL 181 Class 1 duct standard.

While the fire resistant barrier layer can be associated with the polymer core in any known fashion to keep the two together to form the composite duct construction, one mode of association is adhering the fire resistant barrier layer to the outer surface of the polymer core using an adhesive. As an alternative association between the fire resistant barrier layer and the polymer core, the fire resistant barrier layer can have first and second opposing longitudinal edges, with the edges sewn or stitched together such that the fire resistant barrier layer surrounds the outer surface of the polymer core.

While the fire resistant barrier layer can be any type of material that, when surrounding the polymer core, the composite duct structure would meet the UL 181 Class 1 duct standard, a preferred material would be a woven or non-woven fabric material containing fiberglass. An alternative material would be a fire resistant fleece comprising fire resistant staple fibers and optionally char scaffold fibers.

The invention also entails the use of one or more of the flexible uninsulated ducts for moving conditioned or unconditioned air therethrough in a given structure, wherein the one or more flexible uninsulated ducts is in an interior space of a structure, e.g., in floor or walls spaces of the structure, wherein further insulation for the inventive duct is not required.

Another aspect of the invention is the use of a combination of adhesives where the fire resistant barrier material is bonded together as part of the uninsulated duct construction, the combination of adhesives maintaining the integrity of the duct when subject to certain testing in conjunction with meeting requirements to qualify as a UL 181 Class 1 duct.

Another embodiment of the invention entails a flexible uninsulated duct that meets some or all of the Underwriter Laboratories (UL) 181 Class 1 duct standard and that uses a combination of adhesives to facilitate passing certain of the tests required under the UL 181 standard. This combination of adhesives enables the bond between the fire resistant barrier material to maintain its integrity and bonded overlap when subjected to high temperature and/or flame penetration testing and, at the same time, maintain the integrity of the duct construction during duct manufacture.

More particularly, the flexible uninsulated duct includes a polymer core having, optionally, a helical wire as a part thereof, the polymer core having first and second opposing surfaces. Afire resistant barrier layer with opposing first and second surfaces is provided, one of the first and second surfaces of the fire resistant barrier layer facing one of the first and second surfaces of the polymer core, the helical wire, if used, arranged therebetween. One of the first and second surfaces of the fire resistant barrier layer or one of the first and second surfaces of the polymer core forming an inside surface of the flexible uninsulated duct that forms a channel for conditioned air flow. When the polymer film forms the channel, the fire resistant barrier layer is exposed as an outside surface of the flexible uninsulated duct. When the fire resistant barrier layer forms the channel, the polymer film is all exposed as an outer surface of the flexible uninsulated duct.

In the duct construction, portions of the fire resistant barrier layer form an overlap, the overlap being either longitudinal seam running along a length of the duct or a spirally wound seam running along the length of the duct.

In one duct construction, a combination of at least first and second adhesives is provided between overlapping portions of the fire resistant barrier layer, the first adhesive is a hot melt adhesive in an effective amount to immediately bond the overlapping portions together, the second adhesive is a high temperature adhesive in an effective amount to maintain the bond between the overlapping portions when the longitudinal seam or spirally wound seam is subjected to at least a flame penetration test according to the UL 181 Class 1 duct standard.

In an alternative duct construction for the portions of the fire resistant barrier layer forming the overlap in either the longitudinal seam or a spirally wound seam of the duct, where again a combination of at least first and second adhesives between overlapping portions of the fire resistant barrier layer is used, the first adhesive is a hot melt adhesive in an effective amount to immediately bond the overlapping portions together, the second adhesive is a cold glue in an effective amount to maintain the bond between the overlapping portions when the longitudinal seam or spirally wound seam is subjected to a high temperature test according to the UL 181 Class 1 duct standard.

Preferably, the duct is the type that uses the longitudinal seam to bind the fire resistant barrier material together as part of the duct construction of the flexible uninsulated duct.

Preferably, the first adhesive is the hot melt adhesive and the second adhesive is a sodium silicate adhesive where the overlap of the duct will be exposed to flame during flame penetration testing.

Preferably, the first adhesive is the hot melt adhesive and the second adhesive is a cold glue where the overlap of the duct will be subjected to high temperature testing but not flame penetration testing.

When the hot melt adhesive is combined with the high temperature adhesive, e.g., sodium silicate, the hot melt adhesive is in contact with a portion of the sodium silicate adhesive located on at least one portion of the fire resistant barrier layer forming the overlap or the hot melt adhesive is adjacent to the sodium silicate adhesive in the overlap.

In another embodiment, the hot melt adhesive can be in contact with a portion of the sodium silicate adhesive as a continuous or discontinuous strip form or a discontinuous form made up of discrete portions of hot melt adhesive dispersed along the overlap.

When the hot melt adhesive is used with the cold glue, the hot melt adhesive and the cold glue can be kept generally separate from each other in the overlap, for example as adjacent strips of adhesive next to each other.

When the hot melt adhesive is combined with the high temperature adhesive, the hot melt adhesive covers 20-40% of an area of the overlap that is covered with the sodium silicate adhesive applied to the fire resistant barrier layer, preferably 25-35%.

The invention also includes a method of using the flexible uninsulated duct for supplying conditioned or unconditioned air to a space in any kind of structure or building needing such supply of air. The uninsulated nature of the flexible duct makes it ideal for use in inside walls of the structure as no insulated is need for such applications.

Another embodiment of the adhesive combination is the combination of a cold glue to provide the adhesion to maintain the integrity of the duct for processing and the high temperature adhesive to provide the ability to pass the flame penetration test. With this embodiment, the cold glue would require a drying/curing step as part of the cold glue application as, unlike the hot melt glue and its ability to create a bond almost instantaneously, the cold glue needs to set before bonding is complete. The combination of these adhesives would maintain bonding for high-temperature and flame penetration testing.

For the Class 0 embodiment of the invention, the uninsulated flexible duct includes a core made of a polymer material and a helical wire as a part thereof, the polymer material core having inner and outer surfaces and including a first adhesive. The duct also includes a fire resistant barrier material surrounding the outer surface of the polymer material core, the fire resistant barrier material including a seam running longitudinally along the length of the uninsulated flexible duct, the longitudinal seam having an overlap zone that contains at least one second adhesive to maintain an integrity of the longitudinal seam.

The uninsulated flexible duct is free of any vapor barrier and has a flame spread index and smoke developed index of zero (0) as defined in the UL 181 standard noted above for Class 0 ducts.

The uninsulated flexible duct includes one or more of the following features in order to obtain the flame spread and smoke development indices noted above:
a) if the fire resistant barrier material is a woven material, the weave of the woven material is such that the uninsulated flexible duct meets the flame spread index and smoke developed index of zero (0);
b) using an effective amount of the polymer material in the core so that the uninsulated flexible duct meets the flame spread index and smoke developed index of zero (0);
c) including an effective amount of a fire retardant in the polymer material so that the uninsulated flexible duct meets the flame spread index and smoke developed index of zero (0);
d) wherein the polymer material core is a fire retardant containing-film so that the uninsulated flexible duct meets the flame spread index and smoke developed index of zero (0);
e) the first adhesive includes a fire retardant in an effective amount so that the uninsulated flexible duct meets the flame spread index and smoke developed index of zero (0); and
f) the second adhesive includes a fire retardant in an effective amount so that the uninsulated flexible duct meets the flame spread index and smoke developed index of zero (0).

More preferred embodiments of the duct include the fire retardant being a non-halogenated type or a halogenated type, preferably a non-halogenated type.

The fire retardant can be selected from the group consisting of a molybdenum-based flame retardant, a zinc-based fire retardant, aluminum trihydrate (ATH)—with antimony trioxide, aluminum hydroxide, and a phosphorous-containing fire retardant.

The polymer material core can also be a fire retardant-containing film.

As a way of reducing the amount of polymer material, the polymer material core can be a pair of films with the helical wire disposed therebetween, the gauge of the films being 0.0004 inches or less or the polymer material core can be a single film rather than two films, the single film using less polymer material than the two film embodiment.

In one embodiment, the polymer material core is a spirally wound core and an extent of overlap in a spiral winding of the core is such that the uninsulated flexible duct meets the flame spread index and smoke developed index of zero (0). Alternatively, the polymer material core is a spirally wound core and a pitch of the helical wire is controlled to minimize overlap along a length of the uninsulated flexible duct so that the uninsulated flexible duct meets the flame spread index and smoke developed index of zero (0).

Another preferable embodiment is one wherein the vapor barrier free and fire resistant barrier material containing duct includes one or both of the fire retardant-containing first and second adhesives.

The inventive duct as a Class 0 duct can also be used in any method that supplies conditioned or unconditioned air to a space in any desired structure.

### BRIEF DESCRIPTION OF THE DRAWINGS

FIG. 1 shows a cross sectional view of an embodiment of the inventive duct.

FIG. 2 shows an exemplary use of the inventive duct in a wall space.

FIG. 3 shows another embodiment of the inventive duct.

FIG. 4 shows a section of the fire resistant barrier layer of the inventive duct in connection with duct manufacture.

FIG. 5 shows a cross section of the duct of claim 1, wherein the overlap portion of the fire resistant barrier material at the longitudinal seam of the duct uses an adhesive to bond the ends of the fire resistant barrier material together to form the uninsulated duct.

FIG. 6 shows an enlarged part of the overlap “O” of FIG. 5, showing schematically the adhesive combination used in the overlap portion.

FIG. 7 shows the overlap of FIG. 6 with one embodiment of the adhesive combination used to form the longitudinal seam of the duct.

FIG. 8 shows the overlap of FIG. 6 with another embodiment of the adhesive combination used to form the longitudinal seam of the duct.

FIG. 9 shows yet another embodiment of the adhesive combination showing a longitudinal length of the seam.

FIG. 10 shows the overlap of FIG. 6 in a further embodiment of the adhesive combination used to form the longitudinal seam of the duct.

FIG. 11 shows the overlap of the fire resistant barrier material in a spirally wound duct and the adhesive combination in a schematic representation.

### DETAILED DESCRIPTION OF THE INVENTION

The uninsulated duct provides significant advantages over other and similar type ducts. Whereas the entire duct construction of the prior art duct S-TL is designed to meet the UL 181 Class 1 duct standard, the inventive uninsulated duct can be more economically made due to the ability to use what is essentially a stock polymer core and impart a Class 1 duct rating to the duct by associating the polymer core with an outer fire resistant barrier layer such that the polymer core-fire resistant duct construction meets the UL 181 Class 1 duct standard, wherein the duct would pass all of the 15 tests set forth in the UL 181 standard, as distinguished from the connector category for this particular standard.

The polymer core for use with the inventive duct is a typical helical wire-containing polymer core used as part of flexible ducts for conditioned or unconditioned air. Examples of these kinds of polymer cores are described in U.S. Pat. No. 10,767,892 to Campbell et al. and the other prior art disclosed therein. This patent is incorporated in its entirety herein, particularly with respect to its teachings regarding polymer cores for flexible ducts.

A typical polymer core construction includes two layers of a polymer material, e.g., polyolefin, polyester, polyvinyl chloride or mixtures thereof, with polyester terephthalate (PET) being a more preferred polymer, with a helical wire positioned therebetween. With the two polymer layers adhered to each other, the helical wire, which can be either metal or plastic as is known in the art, becomes an integral part of the flexible polymer core. The helical wire provides additional structure to the duct and allows for its compressibility and expansion. The core outer and/or inner surfaces can be metallized as is also well known in the art if a particular duct application requires such metallization.

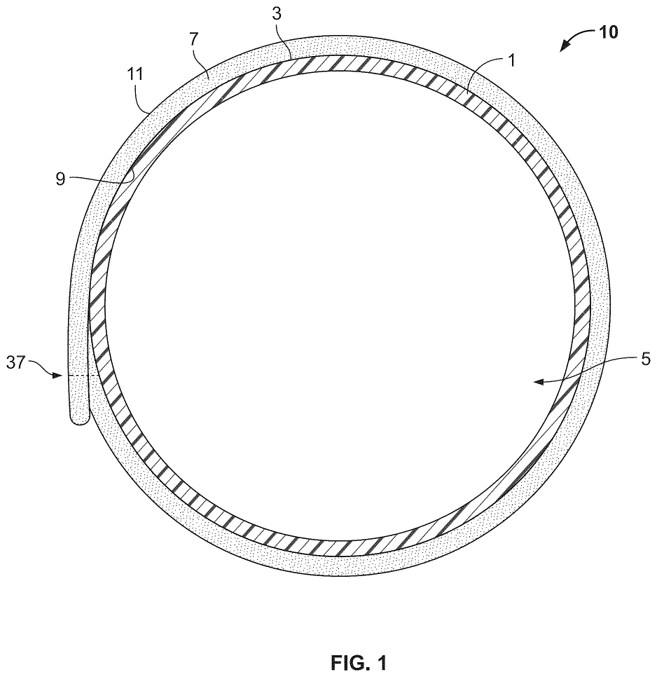

FIG. 1 shows a schematic and sectional view of one embodiment of the inventive flexible uninsulated duct. The inventive uninsulated duct is designated by the reference numeral 10. The polymer core is designated by the reference numeral 1. The helical wire that extends longitudinally through the polymer core is not illustrated in FIG. 1 for simplicity purposes. The polymer core 1 has an outer surface 3 and forms a passageway 5 that allows for conditioned air or the like to flow therethrough.

Surrounding the outer surface 3 of the polymer core is a fire resistant barrier layer 7. The inner surface 9 of the fire resistant barrier layer faces the outer surface 3 of the polymer core. The fire resistant barrier layer 7 includes an outer surface 11, which acts as an exposed surface of the uninsulated duct 10, meaning no other material covers the outer surface 11 of the fire resistant barrier layer. The fire resistant barrier layer 7 is depicted in FIG. 1 as a fibrous or felt-like material but the barrier layer is not limited to just these kinds of materials.

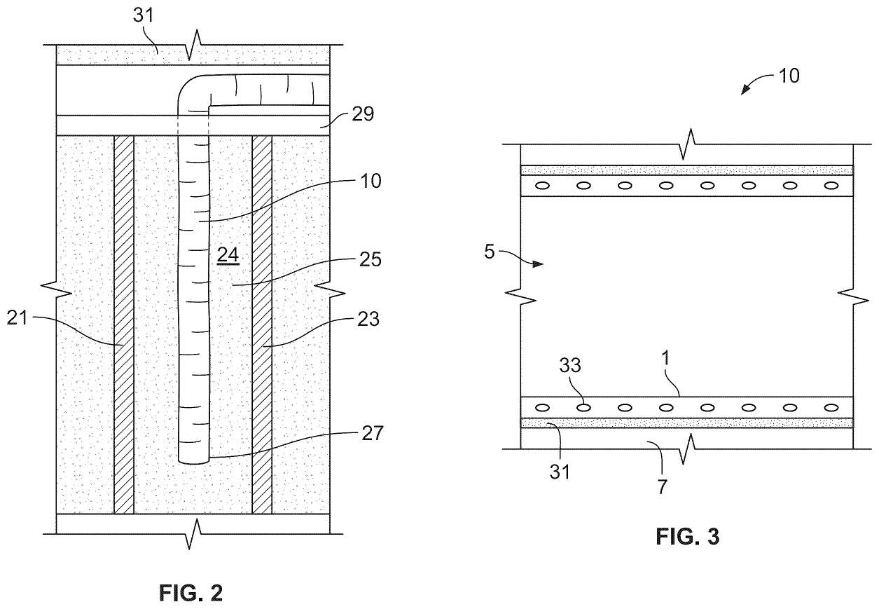

FIG. 2 shows a typical application of the inventive uninsulated duct wherein a schematic diagram of an internal wall portion with interior wall and floor spaces that can utilize the inventive duct is depicted. The diagram shows just one wall of the internal wall portion so that the inventive duct is readily seen in its application. The internal wall portion includes a pair of studs 21 and 23 that together with the walls on either side of the studs 21 and 23 (one wall depicted as 24) form a wall space 25. The inventive duct 10 is shown positioned inside the wall space 25, with a termination 27 that would allow the conditioned or unconditioned air in the duct 10 to enter the interior space through a vent (not shown) in wall 24. The duct 10 can extend through the top sill 29 and further extend through the space between the top sill 29 and upper floor 31 of a two-story structure. In other words, the inventive duct in this example is used in both a wall space and a floor space. However, the inventive duct can be used in any interior space or combination of spaces of a structure, wherein insulation from heat or cold conditions is not required. The inventive duct can be configured in terms of its positioning in the interior spaces of a given structure in any known way.

For purposes of the invention, uninsulated means that the inventive duct does not use any insulating material surrounding the fire resistant barrier layer. While the fire resistant barrier layer as part of the inventive duct may technically have some finite insulating value, the duct is effectively one that is non-insulating as there is no other insulating material associated with the duct. The insulating value of the fire resistant barrier layer is negligible such that a duct that is solely made up of the polymer core and the fire resistant barrier layer is effectively one that does not provide an effective insulating value.

The fire resistant barrier layer can be any material that would provide the required UL 181 Class 1 flame spreading and smoke development resistance, as part of its surrounding of the polymer core. The materials of the fire resistant barrier layer include woven and nonwoven materials, including fiberglass-containing materials, materials that use Nomex fibers, materials that use Nomex fibers in combination with other fibers, materials that may contain ceramic coated fibers/yarns, and the like.

One example of the material that can be used as the fire resistant barrier layer is a fire resistant fleece as disclosed in U.S. Pat. No. 10,443,190 to Wenstrup, which is incorporated in its entirety herein. This fleece includes a fire resistant (FR) fiber, which is defined to be fibers having a limiting oxygen index (LOI) value of 20.95 or greater as determined by ISO 4589-1. The Wenstrup patent provides different examples of these kinds of fibers, e.g., FR resistant rayon staple fibers wherein these fibers are between 20-80% of the weight of the fleece. The fleece also preferably includes a chloride, plurality of char scaffold fibers, which are defined as fibers once burned retaining a portion (at least 80%) of their original strength. Examples of these include mineral fibers such as silica and basalt, aramids, carbon fibers, partially oxidized polyacrylonitride (PAN) and fully carbonized fibers, with the weight percentage of these preferable fibers similar to the FR fibers, i.e., between 20-80% by weight. The fire resistant fleece can also incorporate a scrim as a part thereof and include other non-fire resistant fibers, e.g., polyester fibers, up to a certain weight percentage that does not comprise the fire resistant properties of the fleece.

It is also believed that the fiberglass fabric used in the S-TL duct described above is also a candidate for the fire resistant barrier layer of the inventive duct. High-Temp Suntex textiles also provide a number of different materials, e.g., fire resistant fiberglass fabric, high temperature fiberglass cloths, and woven fiberglass cloths that are believed to be suitable candidates as the fire resistant barrier layer of the inventive duct, see https://www.coatedfiberglassfabric.com/supplier-307158-fire-resistant-fiberglass-fabric, https://www.coatedfiberglassfabric.com/supplier-305933-high-temperature-fiberglass-cloth, and https://www.coatedfiberglassfabric.com/supplier-305861-woven-fiberglass-cloth. Fiberglast also makes woven and nonwoven fiberglass fabrics that are believed to be suitable for use as the fire resistant barrier layer, see https://www.fibreglast.com. Fiberglass-containing fabrics made by Milliken of Spartanburg, South Carolina are also candidates for the fire resistant barrier layer.

The fire resistant barrier layer can have a variety of thicknesses. However, it is preferred that the thickness of the fire resistant barrier layer be kept to just a thickness that would meet the UL 181 Class 1 duct standard rating. Keeping the fire resistant barrier layer to a minimal thickness while still meeting the UL 181 Class 1 duct standard rating reduces the amount of material need to surround the polymer core and keeps costs down. It also provides an overall smaller duct diameter, which facilitates the use of the duct in wall spaces or floor spaces when being used to move conditioned or unconditioned air. Preferably, the fire resistant barrier layer is less than an inch in thickness so that the compressibility of the polymer core is not compromised and the overall diameter of the uninsulated duct does not interfere with its installation in a given interior space.

For felt/fabric type materials, typical thicknesses of these kinds of materials range from 4 to 200 mils (0.004 to 0.2 inches) with a more preferred thickness of 20 to 200 mils (0.02 to 0.2 inches).

The fire resistant barrier layer can be associated with the polymer core in any known fashion. Examples of associations include the use of an adhesive to adhere the inner surface of the fire resistant barrier layer to the outer surface of the polymer core. FIG. 3 shows a schematic of a sectional view of a longitudinal portion of the uninsulsated duct 10 with an adhesive layer 31 disposed between the polymer core 1, containing the wire helix 33, and the fire resistant barrier layer 7.

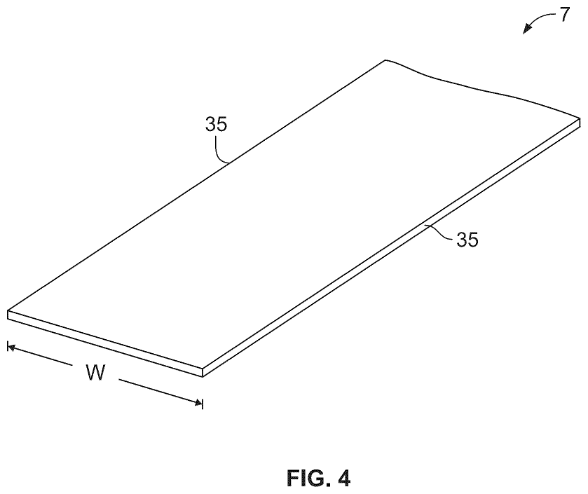

Referring now to FIG. 4, when associating the fire resistant barrier layer with the polymer core, the fire resistant barrier layer 7 is provided or cut to a given width W so as to form opposing longitudinal edges 35, wherein the W corresponds generally to the outer perimeter of the polymer core. The fire resistant barrier layer is wrapped around the polymer core so that the opposing edges either meet or overlap, preferably overlap, to ensure coverage of the polymer core, with one another. As part of the wrapping, an adhesive can be used as described above so that the fire resistant barrier layer is adhered to the polymer core outer surface. Alternatively, the opposing edges 35 can be sewn or stitched together in a manner so that the fire resistant barrier layer is firmly positioned around the polymer core and not susceptible to any significant movement along a length of the polymer core that would disrupt the composite construction and fire rating of the duct. FIG. 1 shows an example of overlapped edges of the fire resistant barrier layer 7 that is stitched together at 37.

Mechanical means could also be employed, e.g., clamps, straps, zip ties, wherein the mechanical attachment is such that the fire resistant barrier layer is held in place when positioned against the outer surface of the polymer core. Combinations of attachment techniques described above are also within the scope of the invention.

The manner of association between the polymer core and fire resistant barrier layer can be accomplished in a batch or continuous method. In a batch method, a given length of polymer core and fire resistant barrier layer are provided and the two are associated together using one of the techniques described above.

In a continuous method, the fire resistant barrier layer could be continually fed along side a moving polymer core, wherein the appropriate machinery could wrap the fire resistant barrier layer around polymer core. A means could be additionally provided for the continuous use of an adhesive or stitching to associate the fire resistant barrier layer with the polymer core and produce the flexible uninsulated inventive duct. The manufactured duct could then be cut to a desired length or a stock length, which could be shortened later for a given application.

Typical duct dimensions can range from 2 to 20 inches, which is the range of available sizes for the prior art S-TL duct. However, for the use of the uninsulated duct in interior spaces, smaller sizes are preferred, e.g., less than 8-10 inches, less than 6 inches, less than 4.5 inches in diameter, and even 3.5 inches or less in diameter. The uninsulated duct could come in virtually any length that a particular application would require, similar to the S-TL duct, whose length as a duct is not limited.

Another aspect of the invention addresses the situation wherein the uninsulated duct may be subject to testing wherein the uninsulated duct with either a longitudinal seam or an uninsulated duct that is spirally wound and has a fire resistant barrier material spirally wound seam would be directly involved in the testing and subject to high temperatures and/or direct flame contact. In these kinds of situations, certain modifications to the duct construction are required to ensure that the integrity of the uninsulated duct is maintained during such testing. This modified construction involves the use of a combination of adhesives in the seams noted above, the combination of adhesives bonding the fire resistant barrier material together in the seam areas of the duct so that the duct maintains its integrity during such testing. While the description of the uninsulated duct above focuses on a longitudinal seam-containing duct, this additional aspect of the duct construction and use of the combination of adhesive also applies to spirally wound ducts employing the fire resistant barrier material.

As noted above, there are a number of standards that are required to be met to obtain a UL 181 Class 1 duct rating. These tests include the flame spreading test noted above as well as flame penetration tests, a high temperature test, and various mechanical tests. In the flame penetration test, a section of duct material, including the helical wire, if present, is placed over a furnace at approximately 1425 F and a weight is placed on the inner layer of duct material. The outer layer of the duct faces the furnace during the flame penetration test. Another test is a high temperature test, wherein an interior of a duct is subjected to a temperature of 265° F. for 60 days. There are other mechanical tests which require that the duct is sufficiently strong to meet these tests.

While the fire resistant barrier layer on its own can easily meet the flame penetration test, the ability to meet this test as well as others, e.g., the high temperature test and certain mechanical tests, can create some issues when considering a duct made using an adhesive to make the duct integral in terms of its various components.

An embodiment, wherein the fire resistant barrier layer would be stitched as is described above, may not have such a problem providing that the stitching is such that it can withstand the temperatures of the UL 181 tests noted above. However, if an adhesive is used, the make up of the adhesive is critical in the ability for the adhesive-containing duct to meet the UL 181 Class 1 duct standards and maintain the integrity of the duct for an intended application.

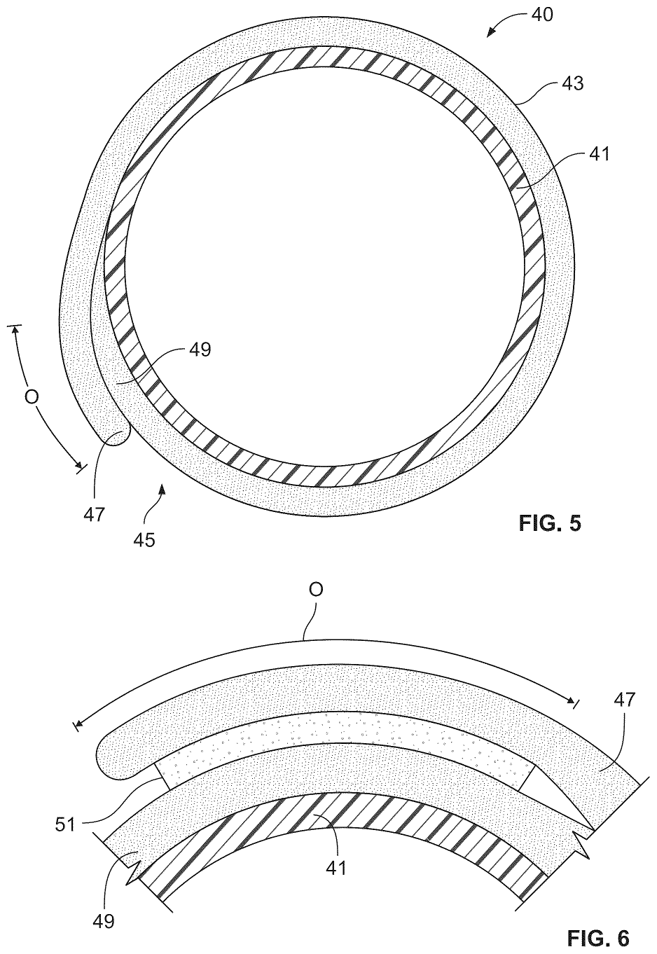

If the stitching mentioned above is replaced with an adhesive for the longitudinal seam-containing uninsulated duct such as shown in FIG. 1, the fire resistant barrier layer material, which wraps around the polymer core, is held together with an adhesive layer such as shown in FIG. 5. In FIG. 5, the adhesive-containing duct is designated by the reference numeral 40. The duct 40 has an inner polymer core 41 and an outer fire resistant barrier layer 43. A seam is designated by the reference number 45, wherein a portion 47 of the fire resistant barrier layer overlaps another portion 49 of the fire resistant barrier layer. This overlap zone is designated by the reference “O” and runs circumferentially around the duct for a limited distance, indicated by the bracketed line with the “O” as a part thereof. It is desirable to minimize the overlap distance while still having enough overlap and adhesive to bond the ends of the fire resistant barrier layer together and maintain the integrity of the bond when the uninsulated duct is tested. Minimizing the overlap is desirable as this means that less fire resistant barrier material and adhesive are used and the overall cost of making the duct is reduced. The actual overlap distance when measured circumferentially can vary, but a desirable range of the overlap can be from ½ inch to 2 inches. Less than ½ inch of overlap means that there may be insufficient amount of adhesive to bond the fire resistant material layer end portions together. With the overlap bonded in place, a longitudinal seam runs longitudinally along the length of the duct. For sake of clarity, the adhesive located between the two portions 47 and 49 to form a bond for the seam is not shown in FIG. 5 but shown in a schematic fashion in FIG. 6, wherein just the overlap is shown.

In FIG. 6, a view corresponding to the overlap “O” of FIG. 5 is shown, wherein the adhesive 51 is shown schematically as between the two portions 47 and 49 of the fire resistant barrier layer 43. A more detailed illustration and description of the configuration of the adhesive as a combination of adhesives between the two portions 47 and 49 is discussed below. The view of FIG. 6 corresponds to the overlap zone “O” of FIG. 5, which is a transverse or lateral cross section of the seam that runs the length of the duct 40.

As noted above, the adhesive represented schematically in FIG. 6 has to be such that the duct 40 will meet all of the tests associated with the UL 181 standard, if the duct has to be subjected to such testing. In other words, the integrity of the adhesive and its holding of the fire resistant barrier layer in place as it surrounds the polymer core must be maintained. For example, without the proper adhesive, the adhesive could break down during the high temperature test and/or flame penetration test and the duct would come apart, thus disqualifying it as a Class 1 duct rated product. In other instances, the adhesive could be such that it maintains the integrity of the bond at the longitudinal seam of the duct, but the adhesive is of the type that the other mechanical testing requirements for the UL 181 Class 1 duct standard could not be met. As an example, the adhesive could be too brittle and fail during one or more of the mechanical tests.

It should be understood that in some testing instances, the longitudinal seam may not be subjected to the flame penetration test. In these testing instances, it may not be necessary to employ all of the adhesive combinations described below. In cases where the longitudinal seam of the duct must be tested, UL does require that the longitudinal seam of a duct be tested for flame penetration and the adhesive used in the overlap portion must be able to pass this test as well as other tests associated with UL 181. Thus, the longitudinal seam construction for the inventive duct may vary depending on whether the flame penetration test must be met. This alternative seam construction when flame penetration testing is not required on the seam or at all is discussed in more detail below.

To meet the high temperature and flame penetration tests, a high temperature glue could be employed for the longitudinal seam of the inventive duct. Ceramic adhesives, which are well known in the art, are one class of glues that would meet these tests. A sodium silicate adhesive, commonly known as a water glass adhesive, can also be used as a high temperature adhesive for the longitudinal seam of the inventive duct. These adhesives can easily withstand the high temperature testing (265° F.) while typically surpassing the flame penetration test temperatures (1425° F.) as well.

There are drawbacks to using a ceramic adhesive alone as the adhesive for the longitudinal seam. These adhesives are very expensive and require curing and/or drying. Moreover, the adhesives tend to be brittle after drying/curing and this brittleness can result in a failure of the seam when the duct is subjected to mechanical testing as part of meeting the UL 181 Class 1 duct standards.

The sodium silicate adhesive, while being a high temperature adhesive and being able to withstand the temperatures encountered during the flame penetration and high temperature testing, shares the same drawback as the ceramic adhesives. That is, it is brittle once cured/dried and meeting the mechanical testing in conjunction with the UL 181 Class 1 duct standards may be difficult to do, particularly when applied alone as a singular adhesive. The sodium silicate adhesive is much less expensive as compared to ceramic adhesives. However, the ceramic type adhesives are generally somewhat easier to apply as the sodium silicate solution is colloidal and resists absorption.

Another potential adhesive for the seam is a cold glue adhesive. Cold glue adhesives are well known in the art. A cold glue adhesive, also called liquid glue or water-based glue, is a type of adhesive that is composed of water, polymer resins, and other additives. It is commonly used in various industries such as woodworking, packaging, bookbinding, and labeling. Cold glue adhesives are typically applied in a liquid form on the surface of the material to be bonded. The water in the adhesive evaporates, and the polymer resins react to form a strong bond.

Cold glue adhesives also have drawbacks in terms of requiring a curing/drying time and inability to withstand the kinds of temperatures used in a flame penetration test.

Yet another kind of adhesive that has potential for the inventive uninsulated duct is a hot melt adhesive. These kinds of adhesives are also well known in the art. That is, a hot melt glue or adhesive, sometimes referred to as hot glue, is a thermoplastic adhesive that is applied in a molten state and hardens as it cools down. It is a popular adhesive due to its strong bonding properties, versatility, and ease of use. These kinds of adhesives are advantageous in that there is no need for curing or drying time. Thus, when making a duct using these kinds of adhesives, the duct integrity is established in a very short period of time, essentially immediately, and manufacturing of ducts with a longitudinal seam or spiral seam can be completed in an efficient manner.

Hot melt adhesives are advantageous in that their bonds are more flexible but strong and seams using these adhesives can meet the mechanical tests associated with the UL 181 Class 1 duct standards. However, hot melt adhesives have relatively low melting points so that a seam having such an adhesive would not hold up under a flame penetration or high temperature test.

The following table shows a matrix of the type of adhesives mentioned above in terms of the properties.

| | | | U1.181 | |
|---|---|---|---|---|
| | UL 181 Flame | UL 181 | Various | Curing/ |
| | Penetration | High Temp. | Mechanical | Drying |
| | (1400° F.) | (265° F.) | Tests | Required |
| Ceramic | Yes | Yes | No | Yes |
| Adhesives | | | | |
| Sodium | Yes | Yes | No | Yes |
| Silicate | | | | |
| Solution | | | | |
| Cold Glue | No | Yes | Yes | Yes |
| Hot melt glue | No | No | Yes | No |

Considering the different kinds of adhesives, certain combinations of adhesives when used in a longitudinal seam of the inventive duct can successfully meet all of the UL 181 Class 1 duct standards, while others may be able to only meet some of them and not be a candidate for use as an adhesive for the inventive duct.

To address the shortcomings in the ceramic adhesives and sodium silicate adhesives, testing was conducted in connection with different adhesive combinations. These high temperature adhesives were mixed with a cold glue as a means to create a bond that will pass the mechanical tests as well as the flame penetration and high temperature tests. However, in testing a combination of the cold glue and either high temperature adhesive, the test results showed only about a 60% pass rate for the flame penetration test. Thus, the cold glue/high temperature adhesive was not deemed an acceptable combination for forming the longitudinal seam of the inventive duct.

Testing was also conducted in terms of adjusting the ratio of the sodium silicate adhesive to the cold glue blends. However, this testing did not show much of an improvement. In this adjustment study, the most stable ratio was approximately 50:50. With lower amounts of the sodium silicate, a ratio less than 50:50 sodium silicate to cold glue, there was not enough sodium silicate to effectively bond the overlap surfaces once the cold glue burned away. Above this ratio, a lot of solids precipitated out of the mixture and led to poor bonding. This mix of adhesives was also not believed to be adequate for passing the flame penetration test given the extreme temperatures seen in this testing.

Another mode of formulating the cold glue and sodium silicate adhesive was tested in terms of applying each separately in the longitudinal seam of the inventive duct. In this type of application, the sodium silicate adhesive, since it is typically a colloidal solution, tended to move and blend with the cold glue. This blending exhibited the same problems as noted above when the cold glue and sodium silicate adhesive were mixed together as an adhesive formulation, i.e., the inability to consistently pass the flame penetration testing.

The use of the cold glue in combination with a high temperature adhesive also created problems in terms of manufacturing complexity in the testing studies conducted on the various adhesive combinations. Since both the cold glue and the high temperature adhesives require a curing/drying time, any seam (longitudinal or spiral wound seam) needs to be mechanically held together until at least the cold glue would set and maintain the integrity of the seam. Without the proper drying/curing time, the seam could separate and the duct would become useless for its intended use.

Based on the above studies, the combination or mixture of a cold glue and high temperature adhesive like a ceramic or sodium silicate adhesive would not be expected to create the necessary bond at the longitudinal or spiral wound seam for the duct to pass all of the UL 181 Class 1 duct testing. A combination of cold glue and high temperature adhesive in the same overlap would be expensive and difficult to manufacture. However, it could still be a possible adhesive combination of effective amounts of the high temperature adhesive and cold glue in certain duct constructions.

Referring back to the table above, combinations of the hot melt glue and a high temperature adhesive are more promising in terms of meeting the UL 181 Class 1 duct standards.

One advantage of the use of a hot melt adhesive as part of a combination of adhesives is the ability of the hot melt glue to provide an immediate bond at the longitudinal or spiral wound seam of the inventive duct. While any hot melt glue that provides the immediate bond at the longitudinal/spiral wound seam is a candidate for use with the inventive duct, including pressure sensitive and non-pressure sensitive hot melt glues, pressure sensitive hot melt glues are preferred. These kinds of adhesives possess a more aggressive initial tack and bond strength making these kinds of hot melt adhesives an ideal candidate for an adhesive combination. Using a hot melt glue avoids the need to somehow mechanically secure the longitudinal/spiral wound seam when a drying/curing time-required adhesive, e.g., the cold glue discussed above, is used.

It is believed that combining the hot melt glue with any kind of high temperature adhesive as an adhesive combination will create a bond at the longitudinal/spiral wound seam immediately when the seam is created. The presence of the high temperature adhesive in the proper quantities in the adhesive combination in the longitudinal/spiral wound seam then creates sufficient adhesion on its own (the hot melt glue burns away in the flame penetration test) to maintain the integrity of the seam when the seam is subjected to the temperatures of the flame penetration test and high temperature test.

While high temperature adhesives like ceramic adhesives are suitable in combination with a hot melt glue, they are undesirable from a cost standpoint. Thus, sodium silicate adhesives are a more preferred high temperature adhesive when the longitudinal seam will be subjected to the flame penetration test.

One reason for preferring the sodium silicate adhesive in combination with the hot melt glue is that the sodium silicate adhesive can be first applied onto the fire resistant barrier material, either on both portions 47 and 49 or only one portion. The hot melt glue is then applied on top of the already-applied sodium silicate adhesive or between if both portions received the sodium silicate adhesive. With the hot melt glue pressed against the sodium silicate adhesive, the sodium silicate adhesive can be forced into the fire resistant barrier material. This penetration of the sodium silicate adhesive into the fire resistant barrier material occurs even when the fire resistant barrier material is the type that is coated with a cold glue as described above when using a coated fire resistant barrier material. Often times, fire resistant barrier materials are coated with an EVA cold glue for example to maintain the integrity of the material when cut, prevent excess fraying at the edges for example. Even with this coating, the application of the hot melt glue onto the sodium silicate adhesive allows the sodium silicate adhesive to penetrate the material, which enhances its flame penetration resistance at the seam. A contributing factor to the ability to successfully use the adhesive on a coated fire resistant barrier material is the fact that the fire resistant barrier material is designed with a particular weave pattern. With the particular weave designs and a light application of the cold glue coating material, the material still retains its porous nature and allows the hot melt glue and high temperature adhesive to bond. The adhesive-containing fire resistant barrier material is closed enough to prevent flame penetration and coated enough with the hot melt glue of the adhesive combination to hold the material together for processing. At the same time, the material is open enough with its coating thereon to allow for optimum bonding. Controlling the amount of the cold glue coating and adding flame retardants to the coating material of the fire resistant barrier material also helps the duct meet the flame spread and smoke generation requirements in the UL 273 tunnel test. The hot glue also penetrates the surfaces of the portions 47 and 49 to form a hot melt glue bond. In essence, a dual bond is formed between the portions 47 and 49, one based on the hot melt glue and one based on the high temperature adhesive, in this case, sodium silicate.

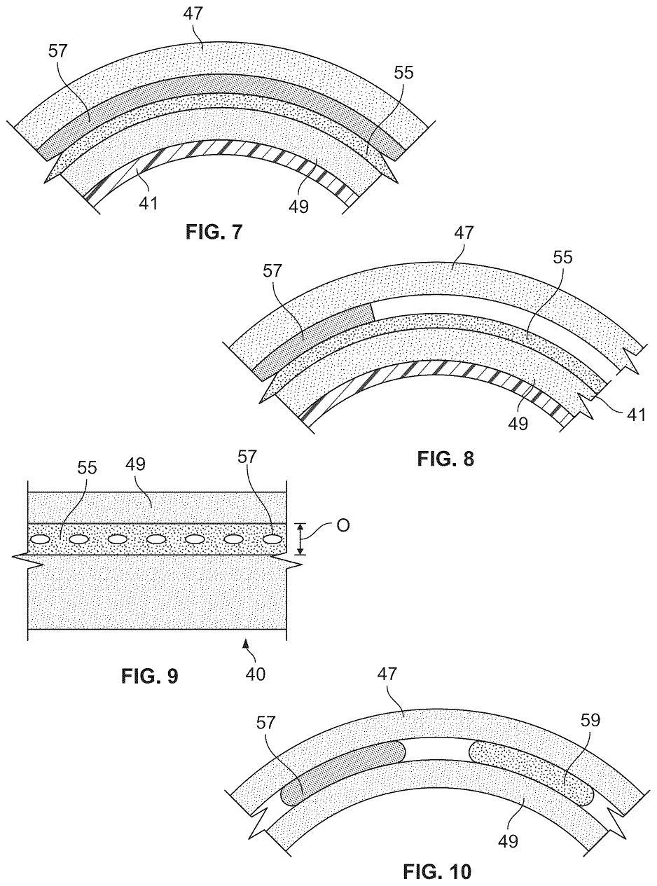

FIG. 7 shows the overlap zone shown in FIG. 6, wherein a combination of the sodium silicate adhesive and hot melt glue are used. In this embodiment, the sodium silicate adhesive is represented by layer 55 and the hot melt glue is represented by the layer 57. As explained above, the sodium silicate adhesive can penetrate into the portion 49 of the fire resistant barrier layer, and this penetration is assisted by the fact that the hot melt glue 51 is applied on top of the sodium silicate adhesive, such application forcing at least some of the sodium silicate adhesive into the portion 4 and the hot melt glue holds the overlap tightly together, thereby allowing intimate contact between portions 47 and 49, which allows the sodium silicate to cure over extended time periods without the silicate bonds being broken prior to curing. As noted above, the sodium silicate could also be applied to the portion 47 as well for additional bonding between the portions 47 and 49. In yet another alternative, the sodium silicate could be applied to the portion 47 and hot melt glue applied between the sodium silicate 55 and portion 49.

As noted above, a longitudinal seam-containing duct may be subjected to the UL 181 flame penetration testing wherein the seam sees the furnace and the weight used in the test is placed on or near the seam. In these kinds of ducts, it is necessary to use the high temperature adhesive as part of the adhesive combination for the longitudinal seam. It is preferred to have the adhesive combination include an effective amount of a hot melt adhesive in combination with an effective amount of the high temperature adhesive in order take advantage of the hot melt glue quickly creating a bond along the seam and the high temperature adhesive providing the advantage of keeping the seam together during the flame penetration test, when the hot melt glue would lose its adhesion properties.

In a preferred embodiment wherein the adhesive combination combines effective amounts of the hot melt glue and sodium silicate adhesive, the two glues can be combined in any way as part of forming the longitudinal seam. Referring to FIG. 8, a preferred method of combining the two adhesives is to cover the fire resistant barrier material, either one or both portions 47 and 49 at the overlap, with the sodium silicate adhesive, which is designated by the reference numeral 55. After this application, the hot melt glue 57 is applied on top of the sodium silicate adhesive, wherein the hot melt covers about 30% of the area of the sodium silicate adhesive that is applied on the fire resistant barrier material. This leaves about 70% of the sodium silicate adhesive exposed, this 70% area forming a high temperature adhesive bond at the overlap. While 30/70 area ratio of hot melt glue to sodium silicate adhesive is a preferred ratio, it is believed that a ratio range of 20-40%, or even preferably 25-35% hot melt glue to 60-80%, (preferably 65-75%) sodium silicate adhesive would also work.

The manner in which the 30% coverage can vary between the use of dots of hot melt glue along the length of the overlap, a longitudinal strip of hot melt glue, lateral or transverse strips that are spaced apart along the length of the overlap or seam, or combinations thereof. FIG. 8 is an example of applying a longitudinal strip of the hot melt glue. FIG. 8 also schematically represents the layering of the adhesives, but in actuality, during the making of the seam, the uncovered high temperature adhesive 55 shown on the portion 49 would bond to the opposing part of the other portion 47. It is also believed that a side by side arrangement of the hot melt glue and sodium silicate adhesive could be used in the overlap area, with an effective amount of hot melt glue to create the instantaneous bond to keep the duct components together during duct manufacture and an effective amount of sodium silicate adhesive to maintain the integrity of the bond at the overlap to and prevent the duct from failing in a flame penetration test.

In yet another alternative and referring to FIG. 9, which shows a view of the overlap in a longitudinal direction as opposed to the transverse views of the overlap in FIGS. 6-8, the hot melt glue can be applied intermittently along the length of the overlap zone. FIG. 9 shows a top view of the duct without the overlap portion 47 so that only the overlap portion 49 receiving the adhesive is shown. Here, the sodium silicate adhesive 55 is applied generally over the entire the overlap portion 49 and the hot melt glue 57 is applied in spaced apart dots or globs along the length of the duct 40.

While not illustrated, the embodiment of FIGS. 7-9 could be modified such that the hot melt glue is applied to the overlap portion 49 and the sodium silicate adhesive applied to the overlap portion 47.

Another aspect of the invention involves the seam of the inventive duct not subjected to the flame penetration test and only being subjected to the high temperature test described above. Thus, there is no need to use a high temperature adhesive if the duct will not see this testing and the only need is for the adhesive combination to use an adhesive that meets the other tests, including the high temperature test.

As noted from the table above, using a cold glue by itself will result in a duct with a longitudinal seam that meets the high temperature test and mechanical tests for UL 181. However, cold glues require curing/drying and these kinds of adhesives are not really preferred from a manufacturing standpoint when making a duct. Due to the nature of HVAC ducts and the need for extended lengths of ducts for various applications, the manufacture of the ducts and producing many feet of duct must be highly efficient. Thus, using cold glues alone may not be a practical solution to meeting the UL 181 Class 1 duct standards. However, providing a combination of adhesives that has effective amounts of the hot melt glue for quickly creating the longitudinal or spiral wound seam with effective amounts of the cold glue to permit passing of the high temperature test of the UL 181 Class 1 duct standards.

While the two kinds of adhesives could be combined in any fashion, it is preferred that the two adhesives are applied in the overlap of the longitudinal seam so that the two adhesives are basically separate from each other so that the effect of each adhesive is optimized. One example of a separate application is to run one bead of the hot melt glue and another bead of the cold glue next to the hot melt glue. Once one portion 47 or 49 of the fire resistant barrier layer is covered with the two adhesives in the overlap zone, another portion of the flame resistant barrier layer is placed in contact with the adhesives to create the longitudinal seam. The separation of the two adhesives can be accomplished in any way and the adjacent beads or strips is just one example of a way to combine the two adhesives in effective amounts. FIG. 10 shows an example of the combination of the hot melt glue and the cold glue for the longitudinal seam of the inventive duct. In this embodiment, a bead of the hot melt glue 57 and a bead of the cold glue, designated by the reference numeral 59 are applied to the overlap portion 49 and then the overlap portion 47 is applied onto the beads 57 and 59 to form a bond for the seam of the duct. While not illustrated, different configurations of the glues 55 and 59 could be used, e.g., discrete dots of the glues could be placed on the overlap portion 49. The dots for each glue could be aligned along the length of the duct. In the alternative, the dots could alternate with different glues so that the hot melt glue and cold glue span the width of the overlap zone rather than be configured to a longitudinal portion thereof.

The amount of the adhesives used in the combinations discussed above depends on the size of the overlap of the longitudinal seam. Larger overlaps will necessarily require more of the adhesives making up the combination. When using a hot melt glue and cold glue, wherein the glues are kept separate, an effective amount of each would be that amount of hot melt glue that maintains the integrity of the seam once the hot melt glue is applied, bond in a matter of seconds. In contrast, an effective amount of cold glue is that which would meet the high temperature test and maintain the integrity of the longitudinal seam as the hot melt glue would be ineffective in terms of bonding at the seam during this test. Examples of amounts include about 0.25 to 2.0 grams per foot.

For the combination of the hot melt glue and high temperature glue like sodium silicate adhesive, the effective amount of the hot melt glue would again be enough to maintains the integrity of the seam once the hot melt glue is applied, bond in a matter of seconds. The effective amount of the high temperature adhesive would be that amount that would maintain the integrity of the seam during both the flame penetration and high temperature tests. It is already established that the high temperature adhesive is not adversely affected by the temperatures present during the flame presentation test so that the adhesive just has to be in a sufficient amount to keep the seam intact during such a test. Examples of amounts include about 0.5 to 5.0 grams per foot.

The adhesive combinations described above can be applied in virtually any way so long as the effective amount of each adhesive is applied in the overlap zone so that the adhesive functions in its intended purpose, i.e., immediate tack and hold for the hot melt glue to hold the seam together, and a sufficient amount of the high temperature adhesive to maintain the integrity of the seam when the seam-containing duct is subject to the flame penetration test or the high temperature test. As mentioned above, the adhesive could be applied to the portion 49 first with the portion 47 applied to the adhesive. In the alternative, the adhesive could be applied to the portion 47 first and then this adhesive containing portion 47 is applied to the portion 49 to form the bond at the overlap zone. Both portions 47 and 49 could be used when applying the combination of adhesives in the overlap zone.

The particular disclosure for an optimum adhesive as addressed above relates to a duct having a longitudinal seam as shown in FIGS. 5-10. However and as noted above, the adhesive as a combination of a cold glue and hot glue or combination of a hot glue and a high temperature adhesive such as a sodium silicate adhesive can also be used when making uninsulated flexible spiral wound ducts that use a fire resistant barrier material in combination with polymer films and a helical wire, the spiral wound ducts using the fire resistant barrier material also candidates to be classified as a UL 181 Class 1 duct.

The making of spiral wound flexible duct is well known in the flexible duct field. This manufacture of conventional ducts generally involves wrapping tapes of polymer film around a mandrel, the wrapping process also including the interleaving of the helical wire and adhesive between the polymer film to form a final flexible duct product.

This kind of spiral wound duct is another embodiment of the invention wherein the adhesive combination is used as part of making a spiral wound duct that employs the fire resistant barrier material. This spiral wound duct using the fire resistant barrier material can be made in any number of ways, each way involving either one or two polymer films in combination with the fire resistant barrier layer as a wrapping material in combination with another polymer film and helical wire, this wrapping material using the adhesive combination when the fire resistant barrier layer overlaps in the spiral wound configuration.

Alternatively and as explained in more detail below, the fire resistant barrier layer alone, coated or uncoated, can be combined with the polymer film and helical wire in a spiral wound configuration. In this embodiment, the fire resistant barrier material is not bonded to any film before manufacturing of the spiral wound duct. The fire resistant barrier material may have a coating on it as described above for the longitudinal seam embodiment of the invention. In this embodiment, the polymer film with the helical wire adjacent to it or considered to be a part thereof can be considered a polymer core, the fire resistant barrier material covering the helical wire and the polymer film. This embodiment contrasts with the polymer core 41 of FIG. 1, wherein the helical wire is disposed between two polymer films, the polymer core then combined with the fire resistant barrier material.

More particularly, one of the ways noted above to make a spiral wound duct using the fire resistant barrier material involves the creation of a two polymer film laminate, the two polymer films surrounding and adhered to the fire resistant barrier material. This two film laminate is then used as a film in combination with the helical wire, another polymer film and adhesive to create a flexible uninsulated duct.

A second way uses a single film laminate of the fire resistant barrier material, this single film laminate being a polymer film adhered to the fire resistant barrier material. This single polymer film laminate is integrated with the helical wire, adhesive, and another polymer film to create a flexible uninsulated duct.

Instead of creating a single film laminate of the fire resistant barrier material for use in making the duct, a variation on this embodiment is forming the duct by spiral winding the two polymer films, the fire resistant barrier material, and the helical wire using the appropriate adhesive in a single operation. In this variation, the step of forming a single or double film laminate for the spiral winding process is eliminated.

A third way involves using a coated fire resistant barrier material in combination with the helical wire, adhesive, and polymer film to create a flexible uninsulated duct. As with the variation described above, the coated fire resistant barrier material is spiral wound with the helical wire, adhesive, and polymer film to form the duct.

For a typical spiral wound prior art duct that employs a pair of polymer films with a helical wire disposed therebetween, a pressure sensitive adhesive is used as the adhesive. However, this kind of adhesive would not stand up to the rigors of UL 181 Class 1 duct testing requirements.

For the spiral wound duct using the fire resistant barrier material, the area of overlap between the fire resistant barrier material needs to be as integral as the overlap portion of the duct of FIG. 5 and its longitudinal seam in order that a spiral wound duct would also pass the UL 181 Class 1 duct standard testing, particularly the flame penetration test and high temperature test.

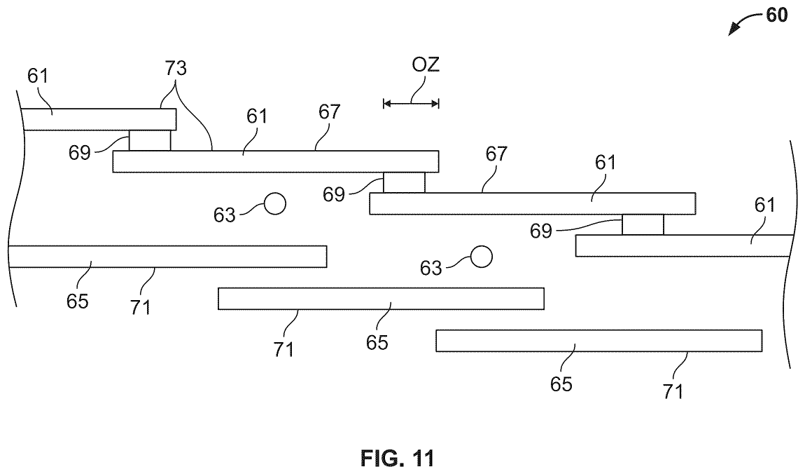

FIG. 11 shows a longitudinal cross sectional view of a wall of a spiral wound duct that is designated by the reference numeral 60. This duct is a schematic representation of a spiral wound duct including the fire resistant barrier layer described above. The embodiments of the use of the fire resistant barrier material are all intended to be represented in the duct configuration of FIG. 11. These embodiments include the double polymer film laminate, wherein the fire resistant barrier material is surrounded by two polymer films, the single polymer film laminate, wherein the fire resistant barrier material is joined with a single polymer film, either before the spiral wound duct is made or as a part of its making, the fire resistant barrier material alone (coated or uncoated) in a construction joined with one polymer film. Each embodiment can include the helical wire as well. For illustration purposes, the fire resistant barrier material, either as a laminate with one or two films or as is, is designated by the reference numeral 61, and called the fire resistant barrier material duct component. The helical wire making up the duct construction is designated as 63 and the polymer film is designated as 65.

FIG. 11 also identifies an overlap zone “OZ” that exists between adjacent wraps 67 of the fire resistant barrier material duct component 61. This overlap zone OZ would have the same adhesive combination that is described in conjunction with the longitudinal seam-containing duct of FIGS. 5-10, the adhesive combination designated schematically as 69. As is known in the art of making spiral wound flexible duct, another adhesive, typically a pressure sensitive adhesive, is used in conjunction with the polymer film to create the laminate construction of the fire resistant barrier material duct component 61, the helical wire 63, and the polymer film 65. For clarity purpose, this adhesive, that would basically join the polymer film windings together as well as join the polymer film to fire resistant barrier material duct component and helical wire, is not shown.

Comparing the longitudinal seam-containing duct of FIGS. 5-10 to that of FIG. 11, the spiral wound duct 60 uses more of the adhesive combination as the overlap zone OZ travels both circumferentially around the duct and longitudinally along the length of the duct. In contrast, the adhesive combination used in the longitudinal seam-containing duct basically extends along the length of the duct; there is no circumferential component of length associated with the longitudinal seam-containing duct. Because of the need for more of the adhesive combination, it is preferred to minimize the size of the overlap zone OZ so as to minimize the amount of adhesive combination necessary to construct the duct 60 as well as minimize the amount of the fire resistant barrier material as this is the most expensive component of the duct 60. Using a larger size overlap zone OZ requires more material for the duct, thus increasing its cost of manufacture. Thus, an overlap zone width of ½ inch to ¾ inch is preferred.

The duct 60 shows only one wall of the flexible uninsulated duct but it encompasses two embodiments of this kind of spiral wound duct. In one embodiment, an outer surface 71 of the wrapped polymer film 65 can form the inner surface of the duct 60 that forms a channel for air flow. An outer surface 73 of the fire resistant barrier material duct component forms an outer surface of the flexible uninsulated duct 60.

However, the duct 60 could be made with an inverse relationship as compared to FIG. 11. That is, the polymer film wraps 65 could be the outer surface of the duct 60 and the fire resistant barrier material duct components 61 could be the inner surface. One advantage of this embodiment relates to the flame penetration test, wherein the outer surface of the duct faces the furnace and flame source. With the outer surface polymer film 65 facing the flame, the helical wire 63 is positioned beneath the fire resistant barrier material duct component 61, thereby giving more support to the fire resistant barrier material duct component 61 during the flame penetration test.

Another embodiment of an uninsulated flexible duct is described below. In this embodiment, the invention is a Class 0 non-insulated flexible duct that meets the requirements of flexible duct standard UL181, and especially the ASTM E84 test that involves flame spread and smoke development. One aspect of the inventive duct is a duct construction that includes a polymer material that forms a core of the duct, a helical wire, a fire resistant barrier material (FRBM), an adhesive as part of the core and an adhesive as part of the fire resistant barrier material, and one that excludes other typical duct components, i.e., a vapor barrier. While similar to the Class 1 non-insulated flexible air duct described above, the inventive duct has modified duct components that allow the duct to be classified as a Class 0 duct per the UL 181 standard noted above, particularly the flame spread and smoke developed indices.

The particulars of the materials making up the duct construction, either alone or in combination, or materials to be excluded from the duct construction, contribute to meeting the ASTM E84 test requirements for the duct to have the Class 0 rating. The duct construction in terms of the arrangement of the FRBM wrapping around the polymer material and helical wire and its adhesive containing longitudinal seam cooperate to allow the duct to meet other test requirements to meet the Class 0 rating, e.g., flame penetration, high temperature tests, etc. that are all part of the UL 181 standard for Class 1 and Class 0 ducts. This kind of a duct construction, including preferred adhesives as part of the fire resistant barrier material layer used in the duct, is described above with respect to FIGS. 1-11 and their description. While the above description lists the preferred adhesives, the Class 0 duct is not necessarily limited to these adhesives and a single adhesive, e.g., a cold glue, that would allow the duct to meet the Class 0 testing requirements (or even Class 1 testing requirements) is also within the scope of the invention. The adhesive or adhesives that are used to form the spiral core could be the same as those used in the seam of the FRBM or different adhesives could be used as part of each duct component as along as the adhesive or adhesives used as part of the duct construction is an adhesive(s) that contributes to meeting either the Class 1 or Class 0 standards.

From these Figures and description, the preferred duct construction is one wherein the polymer material is a polymer core material, the FRBM surrounds the polymer core material and the helical wire is integrated with the polymer core material or is between the outer surface of the polymer core material and the surrounding FRBM material. It is also preferred that the FRBM material is wrapped around the polymer core using a longitudinal seam that runs the length of the duct, the seam including an overlap zone with one or more adhesives to keep the overlap zone intact for duct use and duct testing.

The particulars or exclusions noted above are described in more detail below.

### Exclusion of a Vapor Barrier

The inventive duct does not employ a vapor barrier at all. This exclusion is for a number of reasons. First, no vapor barrier is required because the inventive duct is non-insulated and does not require a vapor barrier. The vapor barriers used for Class 1 flexible ducting are typically made of polyethylene terephthalate (PET) or polyethylene (PE). Also, typically the vapor barriers contain fire retardant (FR) packages to try to hold the performance to Class 1. Usually, the vapor barrier is the poorest performing surface in terms of the ASTM E84 testing. The metallized PET films used on many vapor barriers burn more easily than the clear PET films and require FR in the adhesive to prevent failing the Class 1 testing. The PE is blown extruded and also has FR to prevent excessive flame spread and smoke development. Without the need for insulation, the inventive duct does not require a vapor barrier because the inventive duct is for use where temperature differences between internal and external duct surfaces will not cause condensation. It is not likely that any insulated flexible duct employing a polymeric vapor barrier would be able to achieve a Class 0 rating and the inventive duct does not face this problem as it is an uninsulated flexible duct that does not use a vapor barrier.

### Fire Resistant Barrier Material (FRBM)

The inherent resistance to burning and flame penetration of the FRBM component of the inventive duct is one feature that contributes to attaining the Class 0 rating. The FRBM should be constructed in a manner to prevent penetration by flames or furnace gases, for example a construction that would pass the flame penetration test. Another feature of the invention is the arrangement of the FRBM with the polymer material. That is, it is believed that the FRBM surrounding the outside of the polymer core material helps shield the polymer material during Class 0 testing, wherein the FRBM is face down into the tunnel and the polyester core is above it during tunnel testing. In terms of the FRBM construction, it should be of the type that is less open if the FRBM is a woven like material. A tighter material prevents fire to pass through it and prevent or minimize the flame to burn the polymer material that is behind the tunnel-facing FRBM. With this kind of FRBM, there is little tendency for the polymer core material to burn and generate smoke and adversely affect the results of the ASTM E84 testing.

### Minimizing the Amount of Polymer Core Material

Since the polymer material is the material that would permit flame spread and smoke development, reducing the amount of polymer core material to an effective amount minimizes the amount of material that can generate smoke or allow flame spread and permit the duct to meet the flame spread and smoke developed indices of zero.

Potential ways that the amount of polymer core material can be reduced are as follows.
a) Thinner gauge films could be used to make the polymer material core. Typically, the films are PET and have a thickness or gauge of 0.00043″ PET, which is commonly called 43-gauge film. Thinner films are commercially available, e.g., 0.0003 or 0.0004″ or less. More specific examples are a 32 gauge film, (0.00032 inches) or a 24 gauge film (0.00024 inches). Using thinner films is also advantageous when testing under ASTM E84 test protocols. The thinner films tend to retreat from the flame faster than thicker films as the radiant heat given off by the flame will melt the thinner film more quickly. As the film retreats from the flame, less of it burns. Obviously, what does burn has lower fire load.
b) Instead of the typical use of two films with the helical wire sandwiched therebetween as part of the polymer material core construction, the polymer material core could be made with a single layer film, thus reducing the overall amount of the polymer material. When using a single layer film, the core could be made by trapping the wire in the overlap of the spiral wound single layer film.
c) Another option is to reduce the extent of the film overlap so that less film is used per unit length of the duct. This lower amount of film would also be reflected in the duct section that is used for the Class 0 testing.
d) One can also increase the pitch of the helical wire. By increasing the wire pitch, there are less film overlaps as wider film may be used to make the duct.

One other outcome of reducing the amount of the polymer material is the possible adverse effect on other testing that is required when seeking a Class 0 rating. For example, a pressure test, a negative pressure test, a tensile test, a torsion test, an impact test, etc. are all part of the testing regimen for Class 1 and Class 0 ducts. With a reduced amount of polymer material as the core, whether it be in terms of film thickness, film removal, reduced overlap size or reduced overlap per unit length, the surrounding FRBM can make up for a weaker core and the duct can still pass these mechanical tests.

### Altering the Makeup of the Polymer Material

a) The polymer material as a core could include an FR film. In the alternative, the polymer material core film would be replaced with a film that contains a flame retardant/smoke suppressant. Examples of these kinds of films are Hostophan RUF, Hostophan RNF, Hostaphan WF, Melinex FR240, Melinex FR 32x, DUN-SAFE or similar. Since these fire retardant-containing films are well known, a further description of them is not needed for understanding of this aspect of the invention.

### Altering the Make Up of the Adhesive

a) A FR/smoke suppressant could be incorporated into the adhesive when making the polymer material core and/or the adhesive that is used in the overlap zone of the FRBM. The use of this technique is also well-known practice in connection with flexible ducts that are designed to have an ASTM E84 Class 1 rating—not Class zero—and mostly for the vapor barriers as discussed in above. Smoke generation is the most difficult to drive to zero. Flame retardants help reduce smoke by preventing more material from burning—so the smoke suppressants are typically flame retardants.
b) FR/smoke suppressants for the adhesive can be the halogenated or non-halogenated types. The halogenated FR produce darker smoke when activated and are, thereby, not as preferable as non-halogenated FR under the ASTM E84 test. This is because this test uses opacity to determine the smoke generated. Non-halogenated FR tends to produce lighter smoke and this an advantage in ASTM E84 testing so that these types of FR are more preferred.

Some examples of potential flame retardants/smoke suppressants that could be used with PET films and/or adhesives are the following.
i. Molybdenum-based flame retardants as they offer good smoke suppression;
ii. Some zinc-based FRs;
iii. Aluminum trihydrate (ATH)—with antimony trioxide;
iv. Aluminum hydroxide; and
v. A phosphorous containing-fire retardant, for example, an organic one like a phosphonate ester.

Exemplary loadings includes amounts up to 5 to 10% of the material containing the fire retardant. For example, if the fire retardant is included in the polymer film, it could be up to 10% of the weight of the film. Similarly, the fire retardant could make up to 10% of one or more of the adhesives used in the uninsulated flexible duct. While any one of the features described above could be employed alone to achieve the necessary flame spread and smoke developed indices to garner a Class 0 rating, it is preferred that the vapor barrier free, fire resistant barrier material containing duct includes either a flame retardant film as part of the polymer material core or a flame retardant adhesive, either as part of the seam for the flame resistant barrier material or the adhesive associated with the polymer material core, or both as these combinations present a better duct construction and reduce the likelihood that manufactured ducts may not pass the required tests to qualify for the Class UL181 duct rating.

One unique feature of the uninsulated class zero duct that can be rated as a class zero duct under UL 181 is the combination of the fire resistant barrier material and polymer core that forms a duct construction that is uninsulated and is a duct construction wherein the amount of the polymer in the core is minimized so that the UL 723 test standard is met. A typical gauge for a prior art polymer core is 43 gauge or 0.00043 inches. Applicant has tested polymer cores using a film thickness of 0.00032 (32 gauge) and 0.00024 inches (24 gauge) as cores using these kinds of gauges have a reduced amount of polymer material as compared to the standard gauge, and less polymer material means less smoke generation.

The advantage of combining the fire resistant barrier material with a thin gauge polymer core to create an integral polymer core is that, since the fire resistant barrier material is adhered to the polymer core, the laminate construction provides mechanical properties to the duct that enable it to pass the mechanical testing required as part of obtaining a class zero duct rating.

Normally, the polymer core is tested separately from any insulation or vapor barrier layer for UL testing. One problem that may occur with polymer cores that are subjected to mechanical testing is the potential failure of the polymer core at its overlapped section that extends spirally and along the length of the polymer core. If this overlapped section is minimized, which is an aim of the invention to reduce the total amount of the polymer core material so that it is in an effective amount to ensure that the Class 0 UL 723 testing requirements are met when the core is tested, minimizing the amount of polymer material may result in a reduced surface area for the overlap that exists in the polymer core. This reduced surface area for the overlap results in a lowered shear resistance. Thus, when a polymer core having a reduced overlap is tested mechanically on its own, e.g., pressure testing, tension testing, high temperature testing, the polymer core can pull apart at the seams due to the lower shear resistance, thus causing a test failure.

As noted above, the inventive core with its fire resistant barrier material adhered to the polymer core, provides sufficient strength to the overall core construction such that the mechanical testing, that would normally result in a failure if a polymer core with a reduced overlap was tested on its own and without the fire resistant barrier material, can be successfully passed.

Another aspect of minimizing the amount of material making up the polymer core to ensure compliance with UL 723 is a reduction in thickness of the polymer core film. It is believed that a reduced film thickness will not negatively impact the mechanical testing as film thickness such as 32 gauge, or even 24 gauge, as these films are still robust in their properties when considering the pressure testing, tension testing, high temperature testing, etc., which are part of the UL 181 testing regimen. Thus, such thin films are ideal candidates to pair with the fire resistant barrier material to form an uninsulated duct construction that can meet the Class 0 UL 181 standards as a result of a reduced amount of the polymer core material.

Thus, an aim of the invention to create a Class 0 duct would be to use a polymer film that is in an effective amount to meet the UL 723 standard, the effective amount of film being reflected in terms of a minimum film thickness, e.g., 34 or 24 gauge, or possible lower, 20 (0.00020 inches) or even 16 gauge (0.00016 inches) film and/or minimizing the overlap of the core, e.g., ⅛ inch overlap or even lower, possibly 1/16 inch.

It is believed that with the polymer core film quantity reduced enough, either as a single ply film or two ply films, and/or reduced number or size of overlaps, the film quantity/amount would still be in an effective amount for the duct so that UL 723 test can be passed. This is believed to be the case even without the use of fire retardants in: (1) the adhesives used to make the core; (2) the adhesives that adhere the fire resistant barrier material to the polymer core; and (3) the adhesive used at the overlap for a duct using a longitudinal seam for the fire resistant barrier material. Of course, employing fire retardants in the adhesives listed in (1-3) would also contribute to passing the UL 723 test given their effect to eliminate the generation of fire and smoke.

Another advantage of having a thin gauge for the polymer core is the tendency for this material to retreat from the flame used in the UL 723 testing. In this testing, both sides of the duct material must be tested for smoke development, i.e., both sides of the duct see the flame used in this testing. When the fire resistant barrier material side faces the flame, the smoke generation is nil because this material does not burn. When the polymer material side faces the flame, the advantage of using the thinner gauge material is that this material naturally retreats from heat, i.e., the flame used in the testing. This retreating effect means that the polymer core is subjected to relatively less heat at least in certain areas of the test sample, this also contributing to less smoke generation.

Beside reducing the thickness of the polymer core material, the overlap of material when fabricating the polymer core can be altered as a means to further reduce the amount of polymer material per a unit length of duct. Typically, the overlap is ⅜ or 4 inch and this can be reduced to ⅛ inch or even less, e.g., 1/16 inch, to further reduce the amount of polymer material.

Like the Class 1 duct described above, the Class 0 duct can be used in the same way, i.e., to move conditioned or unconditioned air to a desired space.

As such, an invention has been disclosed in terms of preferred embodiments thereof which fulfills each and every one of the objects of the present invention as set forth above and provides a new and improved uninsulated duct for use in supplying conditioned or unconditioned air to an interior space that does not require additional insulation for the duct, a duct that can received a Class 0 rating under UL 181, and a method of use.

Of course, various changes, modifications and alterations from the teachings of the present invention may be contemplated by those skilled in the art without departing from the intended spirit and scope thereof. It is intended that the present invention only be limited by the terms of the appended claims.

I claim:

1. An uninsulated flexible duct comprising:
a core made of a polymer material and including a helical wire as a part thereof, the polymer material core having inner and outer surfaces and including a first adhesive;
a fire resistant barrier material surrounding the outer surface of the polymer material core, the fire resistant barrier material including a seam running longitudinally along the length of the uninsulated flexible duct, the longitudinal seam having an overlap zone that contains at least one second adhesive to maintain an integrity of the longitudinal seam,
the uninsulated flexible duct being free of any vapor barrier;
the uninsulated flexible duct being a vapor barrier-free uninsulated flexible duct that has a flame spread index and smoke developed index of zero (0) as defined in the UL 181 standard and having one or more of the following features:
a) if the fire resistant barrier material is a woven material, the weave of the woven material is such that the uninsulated flexible duct meets the flame spread index and smoke developed index of zero (0);
b) using an effective amount of the polymer material in the core so that the uninsulated flexible duct meets the flame spread index and smoke developed index of zero (0);
c) including an effective amount of a fire retardant in the polymer material so that the uninsulated flexible duct meets the flame spread index and smoke developed index of zero (0);
d) wherein the polymer material core is a fire retardant containing-film so that the uninsulated flexible duct meets the flame spread index and smoke developed index of zero (0);
e) the first adhesive includes a fire retardant in an effective amount so that the uninsulated flexible duct meets the flame spread index and smoke developed index of zero (0); and
f) the second adhesive includes a fire retardant in an effective amount so that the uninsulated flexible duct meets the flame spread index and smoke developed index of zero (0).

2. The duct of claim 1, wherein the fire retardant is a non-halogenated type or a halogenated type.

3. The duct of claim 2, wherein the fire retardant is a non-halogenated type.

4. The duct of claim 1, wherein the fire retardant is selected from the group consisting of a molybdenum-based flame retardant, a zinc-based fire retardant, aluminum trihydrate (ATH)—with antimony trioxide, aluminum hydroxide, and a phosphorous-containing fire retardant.

5. The duct of claim 1, including the fire retardant containing film as the polymer material core.

6. The duct of claim 1, wherein the polymer material core includes a pair of films with the helical wire disposed therebetween the gauge of the films being 0.0004 inches or less.

7. The duct of claim 1, wherein the polymer material core includes a single film the gauge of the single film being 0.0004 inches or less.

8. The duct of claim 1, wherein the polymer material core is a spirally wound core and an extent of overlap in a spiral winding of the core is such that the uninsulated flexible duct meets the flame spread index and smoke developed index of zero (0).

9. The duct of claim 1, wherein the polymer material core is a spirally wound core and a pitch of the helical wire is controlled to minimize overlap along a length of the uninsulated flexible duct so that the uninsulated flexible duct meets the flame spread index and smoke developed index of zero (0).

10. The duct of claim 1, wherein the vapor barrier free and fire resistant barrier material-containing duct includes one or both of the fire retardant-containing first and second adhesives.

11. In a method of supplying conditioned or unconditioned air to a space using a flexible insulated duct, the improvement comprising using the flexible uninsulated duct of claim 1 for said supplying.
